(19) United States
(12) Patent Application Publication
(10) Pub. No.: US 2011/0095627 A1
(43) Pub. Date: Apr. 28, 2011

(54) INTEGRALLY MOLDED PLASTIC FAN MOTOR FRAME AND SINTERED OIL-IMPREGNATED BEARING STRUCTURE AND METHOD OF MANUFACTURING THE SAME

(75) Inventor: Ping-Ling WANG, TAIPEI CITY (TW)

(73) Assignee: Ping-Ling WANG, TAIPEI CITY (TW)

(21) Appl. No.: 12/749,519

(22) Filed: Mar. 30, 2010

(30) Foreign Application Priority Data
Oct. 27, 2009 (TW) 98136354

(51) Int. Cl. H02K 1/04; H02K 15/14; B29C 45/14

(52) U.S. Cl. 310/43; 29/596; 264/265

(57) ABSTRACT

An integrally molded plastic fan motor frame and sintered oil-impregnated bearing structure includes a plastic fan motor frame and a sintered oil-impregnated bearing integrally enclosed in a central tube of the frame, so that the integrally molded structure is solid and precise. In a method of manufacturing an integrally molded plastic fan motor frame and sintered oil-impregnated bearing structure, a sintered oil-impregnated bearing is prepared and disposed in a mold that is used to integrally form a plastic fan motor frame through injection molding, so that the sintered oil-impregnated bearing is integrally received in a central tube of the plastic fan motor frame when the latter is integrally molded. The integrally molded plastic fan motor frame and sintered oil-impregnated bearing structure is solid and can be easily manufactured at high precision to avoid deformation of the bearing due to compression in press-fitting as in the prior art.

### RELATED APPLICATIONS

This application claims priority to Taiwan Application Serial Number 98136354, filed Oct. 27, 2009, which is herein incorporated by reference.

### FIELD OF THE INVENTION

The present invention relates to an integrally molded structure, and more particularly, to an integrally molded plastic fan motor frame and sintered oil-impregnated bearing structure, as well as a method of manufacturing the same.

### BACKGROUND OF THE INVENTION

A fan motor is usually formed by mounting windings, magnets, and a blade assembly on a frame. A bearing is provided on a center of the frame, and a rotary shaft of the blade assembly is rotatably supported in an axially extended shaft hole of the bearing, so that blades of the blade assembly can be driven to rotate smoothly.

There are various types of bearings. Among others, the sintered oil-impregnated bearing can be easily manufactured at reduced cost and is accordingly widely employed by users.

FIG. 1 is a vertical sectional view of a conventional assembly of a sintered oil-impregnated bearing 400 and a plastic fan motor frame 500. As shown, in the conventional assembly of sintered oil-impregnated bearing and plastic fan motor frame, the sintered oil-impregnated bearing 400 has an annular bearing body 410 and an axially extended shaft hole 420 located at a center of the annular bearing body 410; and the plastic fan motor frame 500 includes a central tube 510 and a seat 520 connected to each other. The sintered oil-impregnated bearing 400 is press-fitted in the central tube 510 of the frame 500. The central tube 510 is provided on an inner wall surface near a lower end thereof with a radially inward protruded flange 511, which serves as a lower limit to define a depth by which the sintered oil-impregnated bearing 400 can be pressed into the central tube 510.

FIG. 2 schematically shows a conventional method of manufacturing an assembly of a sintered oil-impregnated bearing and a plastic fan motor frame. The conventional method includes the steps of preparing a sintered oil-impregnated bearing 400, using a mold to produce a plastic fan motor frame 500 having a central tube 510 and a seat 520 connected to each other; and press-fitting the sintered oil-impregnated bearing 400 in the central tube 510 of the frame 500.

However, the above-described conventional assembly of sintered oil-impregnated bearing and plastic fan motor frame and the method of manufacturing the same have the following disadvantages: (1) increased time, labor and tools are required for press-fitting the bearing 400 in the central tube 510 of the frame 500; (2) high compression pressure applied for press-fitting the bearing 400 in the central tube 510 of the frame 500 tends to cause breaking or damage of the sintered oil-impregnated bearing 400 and results in high bad yield; (3) the sintered oil-impregnated bearing 400 must have an outer diameter larger than an inner diameter of the central tube 510, so that the bearing 400 press-fitted in the central tube 510 can have a predetermined pull-out strength without easily separating from the central tube 510; however, the press-fitting of the bearing 400 with larger outer diameter in the central tube 510 with smaller inner diameter would inevitably produce permanent deformation of the central tube 510 in order to fixedly hold the bearing 400 therein; on the other hand, the deformed central tube 510 further brings shape and structural deformation of the whole sintered oil-impregnated bearing 400; (4) in addition to the shape deformation of the central tube 510 and the bearing 400 in the process of press-fitting the bearing 400 in the central tube 510, the high compression force applied in the press-fitting also produces deformation at an inner wall of the shaft hole 420 in the sintered oil-impregnated bearing 400; and (5) both the deformation at the external structure of the bearing 400 and at the inner wall of the shaft hole 420 in the bearing 400 would result in structural friction between the rotary shaft of the blade assembly and the bearing 400 when the blades are driven to rotate. Such structural friction further causes oil leak and oil throwing. As a result, the blades would finally become stuck in the central tube 510 and the shaft hole 420 of the bearing 400. Such condition forms a long-existing problem in the quality of fans.

### SUMMARY OF THE INVENTION

To overcome the drawbacks in the above-described conventional assembly of sintered oil-impregnated bearing and plastic fan motor frame, it is a primary object of the present invention to provide an integrally molded plastic fan motor frame and sintered oil-impregnated bearing structure that is solid in construction and precise in size.

Another object of the present invention is to provide a method of manufacturing an integrally molded plastic fan motor frame and sintered oil-impregnated bearing structure in an easy and convenient way.

To achieve the above and other objects, an aspect of the present invention provides an integrally molded plastic fan motor frame and sintered oil-impregnated bearing structure, which includes a sintered oil-impregnated bearing having an annular bearing body and an axially extended shaft hole defined at a center of the annular bearing body, and the annular bearing body having two opposing first end and second end; and a plastic fan motor frame including a central tube and a seat integrally connected to each other, the central tube being integrally molded to fixedly wrap around the annular bearing body of the sintered oil-impregnated bearing, and the central tube being provided on an inner wall surface with two axially spaced and radially inward protruded first flange and second flange for respectively fixedly bearing on the first end and the second end of the annular bearing body of the sintered oil-impregnated bearing. Thus, the sintered oil-impregnated bearing is more stably and precisely associated with the plastic fan motor frame.

To achieve the above and other objects, another aspect of the present invention provides a method of manufacturing an integrally molded plastic fan motor frame and sintered oil-impregnated bearing structure. The method includes the steps of (1) preparing a sintered bearing having an annular bearing body and an axially extended shaft hole defined at a center of the annular bearing body; and impregnating the sintered bearing with an oil to form a sintered oil-impregnated bearing; (2) preparing a mold having an injection molding chamber; the injection molding chamber consisting of a central tube injection molding chamber and a seat injection molding chamber communicating with each other, and being used to mold a plastic fan motor frame with integrally connected central tube and seat; (3) disposing the sintered oil-impregnated bearing in the mold at a position corresponding to the central tube injection molding chamber; (4) injecting a molten plastic material into the injection molding chamber of the mold, so that the molten plastic material injected into the central tube injection molding chamber closes around the annular bearing body; and (5) waiting until the molten plastic material is set and then removing the mold; and the set plastic material forming the plastic fan motor frame with the central tube thereof fixedly wrapped around the annular bearing body, so that an integrally molded plastic fan motor frame and sintered oil-impregnated bearing structure is completed to have solid construction and precise size.

According to a preferred embodiment of the present invention, the mold includes a male mold and a female mold corresponding to the male mold, and the male and the female mold are closed to each other to define the injection molding chamber therebetween; and the male mold internally includes a supporting post located at a position corresponding to a center of the central tube injection molding chamber for supporting the prepared sintered oil-impregnated bearing therearound.

According to a preferred embodiment of the present invention, the central tube injection molding chamber of the mold is internally provided at positions corresponding to a first and a second end of the sintered oil-impregnated bearing respectively with a first annular recess and a second annular recess that are axially spaced from each other; whereby when the mold is removed, a first and a second radially inward protruded flange axially spaced from each other are formed on the plastic fan motor frame at positions corresponding to the first and the second recess, respectively, and the first and the second flange fixedly bear on the first and the second end, respectively, of the annular bearing body of the sintered oil-impregnated bearing, so that the bearing is more stably and firmly associated with the plastic fan motor frame.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a vertical sectional view of a conventional assembly of a sintered oil-impregnated bearing and a plastic fan motor frame;

FIG. 2 schematically shows a conventional method of manufacturing an assembly of a sintered oil-impregnated bearing and a plastic fan motor frame;

FIG. 3 is a vertical sectional view of an integrally molded plastic fan motor frame and sintered oil-impregnated bearing structure according to a preferred embodiment of the present invention;

FIG. 4 is a vertical sectional view showing a mold for manufacturing the integrally molded plastic fan motor frame and sintered oil-impregnated bearing structure according to the present invention; and

FIG. 5 is a flowchart showing the steps included in a method of manufacturing the integrally molded plastic fan motor frame and sintered oil-impregnated bearing structure according to the present invention.

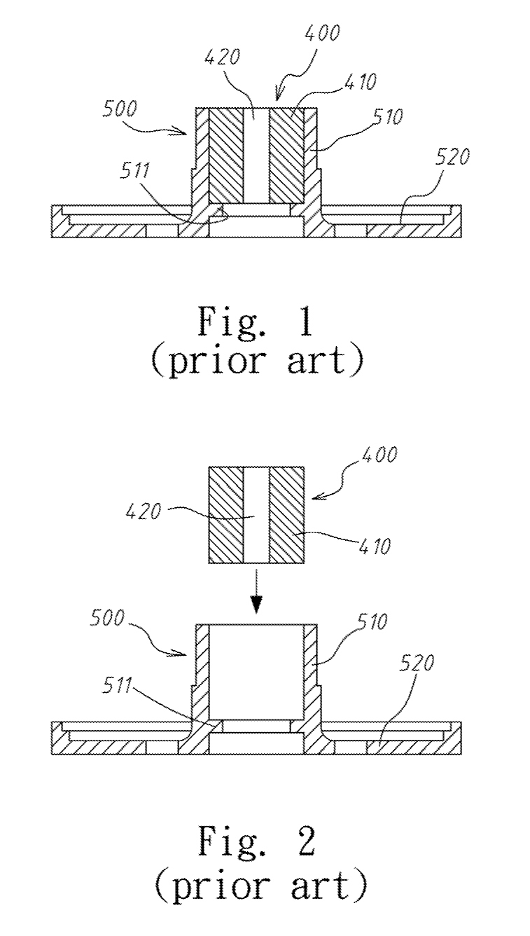

### DETAILED DESCRIPTION OF THE PREFERRED EMBODIMENTS

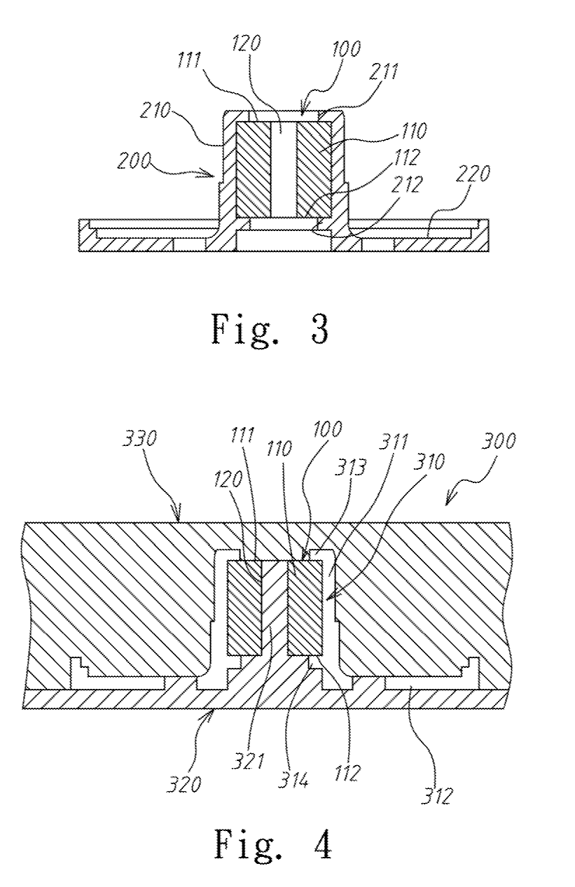

Please refer to FIG. 3, which is a vertical sectional view of an integrally molded plastic fan motor frame and sintered oil-impregnated bearing structure according to a preferred embodiment of the present invention. As shown, the integrally molded plastic fan motor frame and sintered oil-impregnated bearing structure includes a sintered oil-impregnated bearing 100 and a plastic fan motor frame 200.

The sintered oil-impregnated bearing 100 includes an annular bearing body 110 that defines an axially extended central shaft hole 120. The annular bearing body 110 has two opposing first and second ends 111, 112. In practical implementation of the present invention, the sintered oil-impregnated bearing 100 is made by sintering metal powder and then impregnating the sintered bearing with oil.

The plastic fan motor frame 200 includes a central tube 210 and a seat 220 integrally connected with the central tube 210. The central tube 210 is integrally molded to fixedly wrap around the annular bearing body 110 of the sintered oil-impregnated bearing 100. The central tube 210 is provided on an inner wall surface with two axially spaced and radially inward protruded first flange 211 and second flange 212 for fixedly bearing on the first end 111 and the second end 112 of the annular bearing body 110 of the sintered oil-impregnated bearing 100.

According to the preferred embodiment of the present invention, the sintered oil-impregnated bearing 100 is enclosed in the central tube 210, the first flange 211, and the second flange 212 when the plastic fan motor frame 200 is integrally molded. Therefore, the sintered oil-impregnated bearing 100 is stably, firmly, and precisely associated with the plastic fan motor frame 200.

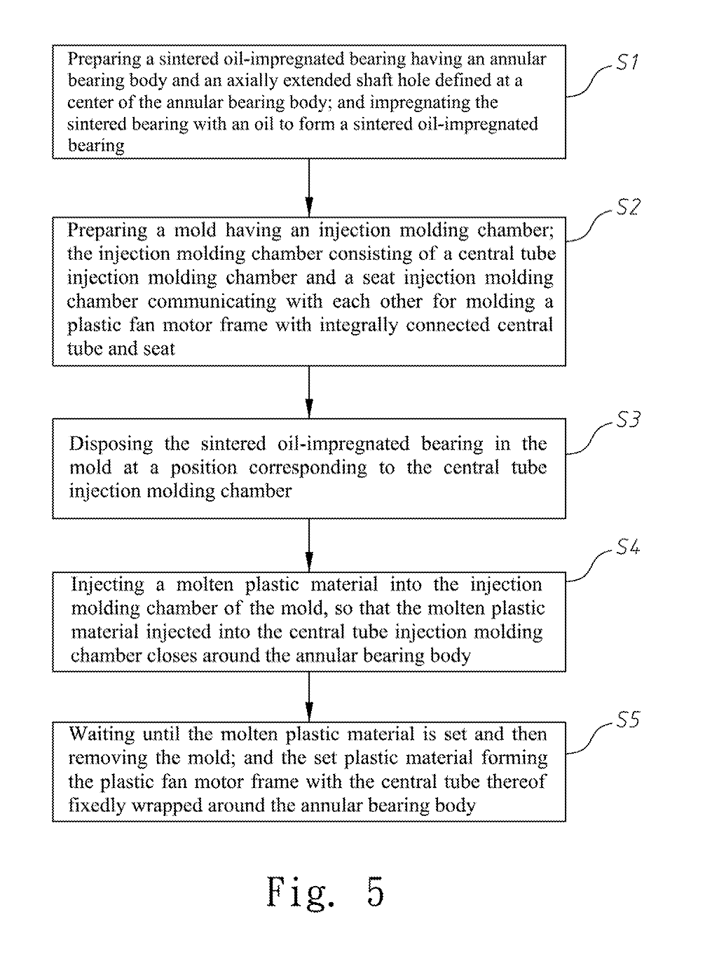

FIG. 4 is a vertical sectional view showing a mold for manufacturing the integrally molded plastic fan motor frame and sintered oil-impregnated bearing structure according to the present invention; and FIG. 5 is a flowchart showing the steps included in a method of manufacturing the integrally molded plastic fan motor frame and sintered oil-impregnated bearing structure according to the present invention. Please refer to FIGS. 4 and 5. The manufacturing method includes the following steps:

Step S1: Prepare a sintered bearing having an annular bearing body 110 and an axially extended shaft hole 120 defined at a center of the annular bearing body 110; and impregnate the sintered bearing with an oil, such as a lubricant oil, to form a sintered oil-impregnated bearing 100. The annular bearing body 110 has two opposing first end 111 and second end 112.

Step S2: Prepare a mold 300 having an injection molding chamber 310. The injection molding chamber 310 consists of a central tube injection molding chamber 311 and a seat injection molding chamber 312 communicating with each other, and is used to mold a plastic fan motor frame 200 with integrally connected central tube 210 and seat 220. In the central tube injection molding chamber 311, there are provided at positions corresponding to the first and the second end 111, 112 of the sintered oil-impregnated bearing 100 with a first annular recess 313 and a second annular recess 314, respectively. The first and the second annular recess 313, 314 are axially spaced from each other, and are used to form two axially spaced and radially inward protruded first flange 211 and second flange 212 on an inner wall surface of the central tube 210. The mold 300 includes a male mold 320 and a corresponding female mold 330. The male mold 320 and the female mold 330 are closed to each other to define the injection molding chamber 310 therebetween. The male mold 320 internally includes a supporting post 321 for supporting the prepared sintered oil-impregnated bearing 100 therearound. The supporting post 321 is located at a position corresponding to a center of the central tube injection molding chamber 311.

Step S3: Dispose the sintered oil-impregnated bearing 100 in the mold 300 at a position corresponding to the central tube injection molding chamber 311. That is, the sintered oil-impregnated bearing 100 is disposed in the mold 300 with the shaft hole 120 engaged with the supporting post 321 of the male mold 320.

Step S4: Inject a molten plastic material into the injection molding chamber 310 of the mold 300, so that the molten plastic material injected into the central tube injection molding chamber 311 closes around the annular bearing body 110. Meanwhile, the molten plastic material injected into the first and the second annular recess 313, 314 bears on the first end 111 and the second end 112 of the annular bearing body 110, respectively.

Step S5: Wait until the molten plastic material is set and then remove the mold 300. The set plastic material forms a plastic fan motor frame 200 with the central tube 210 thereof fixedly wrapped around the annular bearing body 110, and the first flange 211 and the second flange 212 respectively fixedly bear on the first and the second end 111, 112 of the annular bearing body 110. Thus, an integrally molded plastic fan motor frame and sintered oil-impregnated bearing structure is completed.

According to the method of the present invention, the sintered oil-impregnated bearing 100 is integrally received in the central tube 210 when the plastic fan motor frame 200 is integrally molded. The integrally molded plastic fan motor frame and sintered oil-impregnated bearing structure can therefore be easily manufactured to largely save the time, labor and tools needed to assemble the fan motor frame and the bearing to each other. Further, the integrally molded plastic fan motor frame and sintered oil-impregnated bearing structure is solid and stable to avoid any deformation at exterior and interior of the bearing caused by press-fitting in the conventional way of assembling the bearing to the central tube of the plastic fan motor frame. Therefore, with the present invention, it is able to ensure the precision of the bearing and accordingly upgrade the quality of fan motor and extend the usable life thereof.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An integrally molded plastic fan motor frame and sintered oil-impregnated bearing structure, comprising:
a sintered oil-impregnated bearing having an annular bearing body and an axially extended shaft hole defined at a center of the annular bearing body; and the annular bearing body having two opposing first end and second end; and
a plastic fan motor frame including a central tube and a seat integrally connected to each other; the central tube being integrally molded to fixedly wrap around the annular bearing body of the sintered oil-impregnated bearing; and the central tube being provided on an inner wall surface with two axially spaced and radially inward protruded first flange and second flange for respectively fixedly bearing on the first end and the second end of the annular bearing body of the sintered oil-impregnated bearing.

2. A method of manufacturing an integrally molded plastic fan motor frame and sintered oil-impregnated bearing structure, comprising the following steps:
preparing a sintered bearing having an annular bearing body and an axially extended shaft hole defined at a center of the annular bearing body; and impregnating the sintered bearing with an oil to form a sintered oil-impregnated bearing;
preparing a mold having an injection molding chamber; the injection molding chamber consisting of a central tube injection molding chamber and a seat injection molding chamber communicating with each other, and being used to mold a plastic fan motor frame with integrally connected central tube and seat;
disposing the sintered oil-impregnated bearing in the mold at a position corresponding to the central tube injection molding chamber;
injecting a molten plastic material into the injection molding chamber of the mold, so that the molten plastic material injected into the central tube injection molding chamber closes around the annular bearing body; and
waiting until the molten plastic material is set and then removing the mold; the set plastic material forming the plastic fan motor frame with the central tube thereof fixedly wrapped around the annular bearing body, so that an integrally molded plastic fan motor frame and sintered oil-impregnated bearing structure is completed.

3. The manufacturing method as claimed in claim 2, wherein the mold includes a male mold and a female mold corresponding to the male mold, and the male and the female mold being closed to each other to define the injection molding chamber therebetween; and the male mold internally including a supporting post located at a position corresponding to a center of the central tube injection molding chamber for supporting the prepared sintered oil-impregnated bearing therearound.

4. The manufacturing method as claimed in claim 3, wherein the annular bearing body of the sintered oil-impregnated bearing has two opposing first end and second end, and the central tube injection molding chamber of the mold is internally provided at positions corresponding to the first and the second end of the sintered oil-impregnated bearing respectively with a first annular recess and a second annular recess that are axially spaced from each other; whereby when the mold is removed, a first and a second radially inward protruded flange axially spaced from each other are formed on the plastic fan motor frame at positions corresponding to the first and the second recess, respectively, and the first and the second flange fixedly bear on the first and the second end, respectively, of the annular bearing body of the sintered oil-impregnated bearing.
